(19) United States
(12) Patent Application Publication
(10) Pub. No.: US 2011/0291942 A1
(43) Pub. Date: Dec. 1, 2011

(54) DISPLAY METHOD, APPLICATION PROGRAM AND COMPUTER READABLE MEDIUM FOR COMPUTER KEY FUNCTION

(75) Inventors: Yu CHEN, Taipei (TW); Kun-Lin Wu, Taipei (TW)

(73) Assignee: SHUTTLE INC.

(21) Appl. No.: 12/839,886

(22) Filed: Jul. 20, 2010

(30) Foreign Application Priority Data
Jun. 1, 2010 (TW) 099117604

(51) Int. Cl. G06F 3/02

(52) U.S. Cl. 345/172

(57) ABSTRACT

A display method, an application program and a computer readable medium for displaying key function are disclosed. The display method for computer key function includes steps user pressing a special keys on the keyboard, triggering an internal embedded controller in the computer and further detecting hardware function set up in the computer via a basic input output system. Thus, function descriptions are displayed on a screen according to hardware function set up in the computer, wherein the hardware function and function descriptions correspond to each function key on the keyboard. Accordingly, it is not required to replace keyboard with different printed function reminding pattern when hardware functions of the computer is changed.

### BACKGROUND OF THE INVENTION

1. Field of the Invention

The present invention relates to a computer display method, an application program and a computer readable medium, in particular relates to a display method, an application program and a computer readable medium for displaying key function.

2. Description of Prior Art

The hardware functions of a computer are triggered by input device. The most frequent seen input device is a keyboard and a mouse. A user presses the input device to trigger an internal embedded controller (EC) in a computer. Then, the EC sends a signal to operating system (OS) of the computer, such as Microsoft Windows and Apple Mac OS X OS. Consequently, the OS moves to control execution of corresponding hardware function. Yet, as computer hardware functions grow rapidly, input devices have limited corresponding modifications in design to meet such change. In the example of the keyboard mentioned above, an internal keyboard in a notebook or external keyboard for a desktop computer are designed with a standard configuration. Manufacturers may self-define additional keys; still the overall configuration follows the standard keyboard configuration. Accordingly, people skilled in the art are working to develop technologies such that a keyboard with limited quantity of keys is capable of delivering hardware functions updated and growing as the computer technology advances.

FIG. 1 is a schematic diagram of a prior art notebook keyboard and an external keyboard. As shown in the diagram. The keyboard 1 and 1′ are constituted by a plurality of text keys 11, a control keys 12 and function keys 13. The plurality of function keys 13 are constituted by respectively from F1 key to F12 key and Esc key. The plurality of control keys 12 have a Fn key 121 used for forming key combination with one of the plurality of function keys 13 whereby computer is triggered to execute corresponding function. For example, the notebook available in the market typically predetermines that when a user presses the key combination of Fn key 121+F8 key the function of switching screen is performed to switch the computer screen output from output to a computer to output to a projector.

Using a key combination of the Fn key 121 and one of the plurality of function keys 13 for triggering executing specific hardware function is generally applied to computers in the current market. With such application, the keyboard 1 and 1′ are used for triggering hardware functions such as entering into standby mode or hibernation mode, adjusting brightness or volume, switching screen and performing On Screen Display (OSD) and power on/off a webcam etc. Accordingly, it is not required to constantly increase key quantity of the keyboard 1 and l′, which adds up the keyboard manufacturing cost.

As shown in FIG. 2, plurality of function keys 13 on a keyboard available in the market have corresponding function reminding patterns 131 printed in production used for reminding users of the function to perform as the Fn key 121 and the function keys 13 are pressed together. In addition, each keyboard complies with a standard configuration as well as similar the dimension design. Therefore, the printed area of the function reminding patterns 131 is largely restricted. In particular, if a computer has specific setup to define one function key 13 for performing multiple hardware functions, a single function key 13 with multiple function reminding patterns 131 of all defined hardware function printed on is difficult to recognize to users.

In order to resolve the above problems, a concept is proposed to use a computer screen for displaying corresponding functions of the function keys 13. For example, R.O.C. patent no. 1262442 discloses a Fn-key control system having menu function and a method for the same. The control method used in the utility patent is: a EC in the computer detects a first key (for example a Fn key) is triggered by pressing, the EC sends the triggered signal for launching an application program. The application program is launched and displays function reminding menu. Then, the EC detects a second key is pressed and determines the key type of the second key pressed (for example, a function key, a direction key or a mouse button) to execute the corresponding function defined to perform by pressing the second key, display assistant description menu and function set-up menu or terminate the application program.

In the utility patent, the application program is used for displaying the function reminding menu to allow a user to use direction key or a mouse button to select a corresponding item in the function reminding menu to further display the assistant description menu. Accordingly, the user is informed of hardware functions associated with each function key from the function reminding menu and is informed of related information of each hardware function from the assistant description menu.

However, a user can be informed of the corresponding hardware function of each the function key 13 from the function reminding menu of the above mentioned utility patent, the content of the function reminding menu is provided by the application program compiled. The determined corresponding items do not update as the computer hardware functions add/discard, or do not update automatically as the corresponding association between the hardware functions and respective the function keys 13 changes. When computer hardware functions change, the corresponding items provided by the function reminding menu then become incorrect. Thus, the above mentioned utility patent does not completely resolve the problem using function reminding patterns 131 as function reminders.

As discussed above, each computer provides various hardware functions. The hardware functions of the same computer vary once the user changes the function setup. It is general that manufacturers have to print various function reminding patterns 131 for alternative computer hardware setups. Consequently, the production cost is increased. In addition, a user is required to replace the keyboard with a keyboard with corresponding function reminding patterns 131 printed if the computer hardware function add or discard. Such that, hardware upgrade becomes more inconvenient and costly. For example, if a certain computer hardware function is discarded, the keyboard is not replaced accordingly. The user then is confused not knowing if the corresponding hardware function associated with the function key 13 with the function reminding pattern 131 printed on the keyboard works or not and further misuses the function keys 13.

### SUMMARY OF THE INVENTION

The major objective of the present invention is to provide a display method for displaying computer key function, wherein corresponding function descriptions of each function key is displayed on screen upon special keys on a computer keyboard is pressed.

The another objective of the present invention is to provide an application program installed in a computer for enable the computer to execute a display method for displaying computer key function, wherein corresponding function descriptions of each function key is displayed on screen upon special keys on a computer keyboard is pressed.

The still another objective of the present invention is to provide a computer readable medium installed with an application program. When the computer readable medium is loaded to a computer and installs the application program in the computer. The computer is enabled to execute a display method for displaying computer key function, wherein corresponding function descriptions of each function key is displayed on screen upon special keys on a computer keyboard is pressed.

In order to achieve the above objectives, in the method according to the present invention, a user presses a special keys on a keyboard to trigger an internal embedded controller in the computer and the basic input output system of the computer detects hardware functions set up in the computer, whereby function descriptions of the hardware function provided by the computer are displayed on screen. The hardware functions and function descriptions correspond to each function key on the keyboard.

Compare to prior art, the advantages provided by the present invention are that users is informed of function descriptions of corresponding hardware functions of each function key on the keyboard directly from computer screen. Accordingly, it is not required to print different corresponding function reminding patterns on a computer keyboard of computers having different hardware function. Users are allowed to use one keyboard with computers having various hardware functions, such that hardware upgrade cost is reduced. Further, manufacturers are not required to print different function reminding patterns on different keyboard models, which lowers the production cost and simplified the production procedures.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a prior art notebook keyboard;

FIG. 2 is a schematic diagram of a prior art external keyboard;

FIG. 3 is a schematic diagram for function display according to a preferred embodiment of the present invention;

FIG. 4 is a block diagram according to a preferred embodiment of the present invention;

FIG. 5A is a schematic diagram of a function illustrating picture of a preferred embodiment of the present invention;

FIG. 5B is a schematic diagram of a function illustrating picture of another preferred embodiment of the present invention;

FIG. 5C is a schematic diagram of a function illustrating picture of still another preferred embodiment of the present invention;

FIG. 5D is a schematic diagram of a function illustrating picture of the other preferred embodiment of the present invention;

FIG. 6 is a flow chart according to a preferred embodiment of the present invention; and

FIG. 7 is a flow chart according to another preferred embodiment of the present invention.

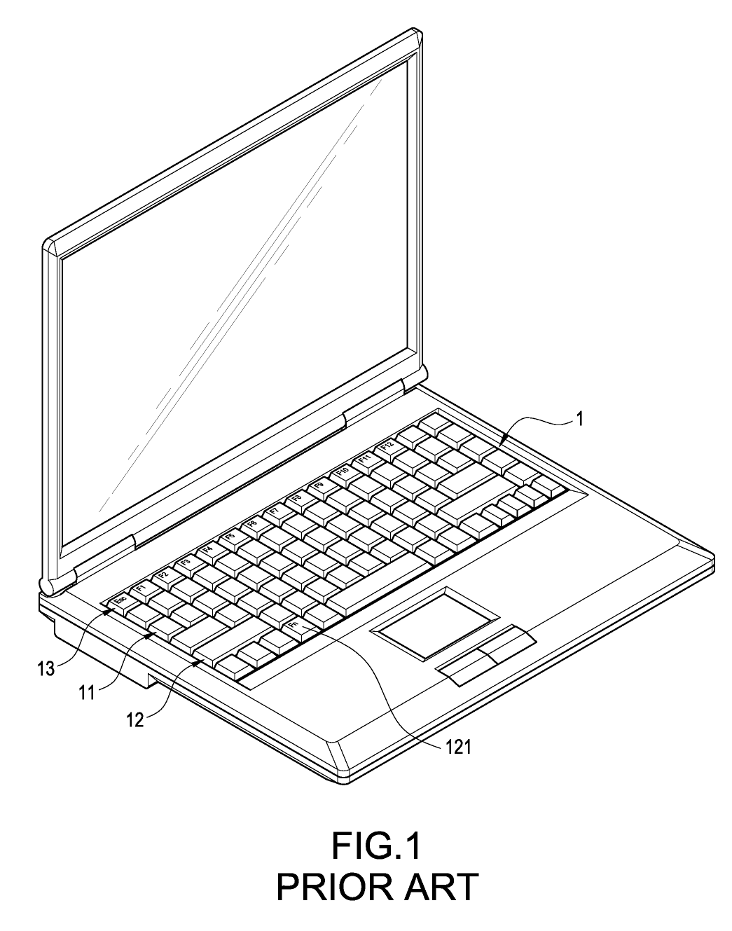

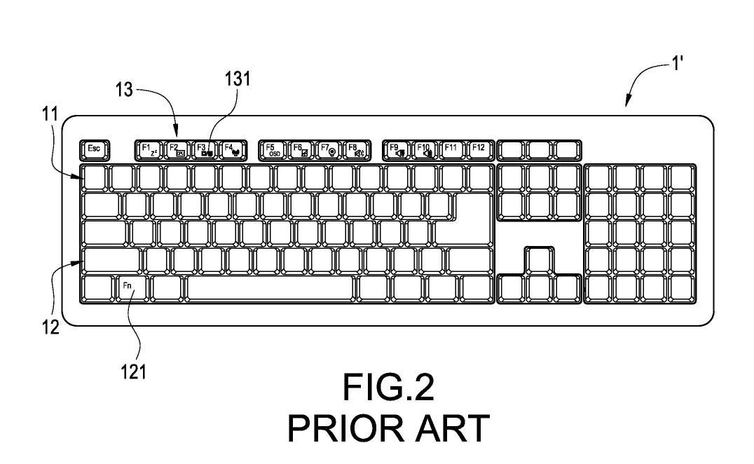

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

A computer readable medium of the present invention is saved with an application program. When the computer readable medium is loaded to a computer, the application program is enabled to install in the computer. Further, the application program executes the display method for displaying computer key function of the present invention. In addition to saving the application program of the present invention of the present invention in the computer readable medium the application program also can be transmitted by other means (such as Internet). When the application program is downloaded and installed to the computer, the application executes the display method for displaying computer key function of the present invention.

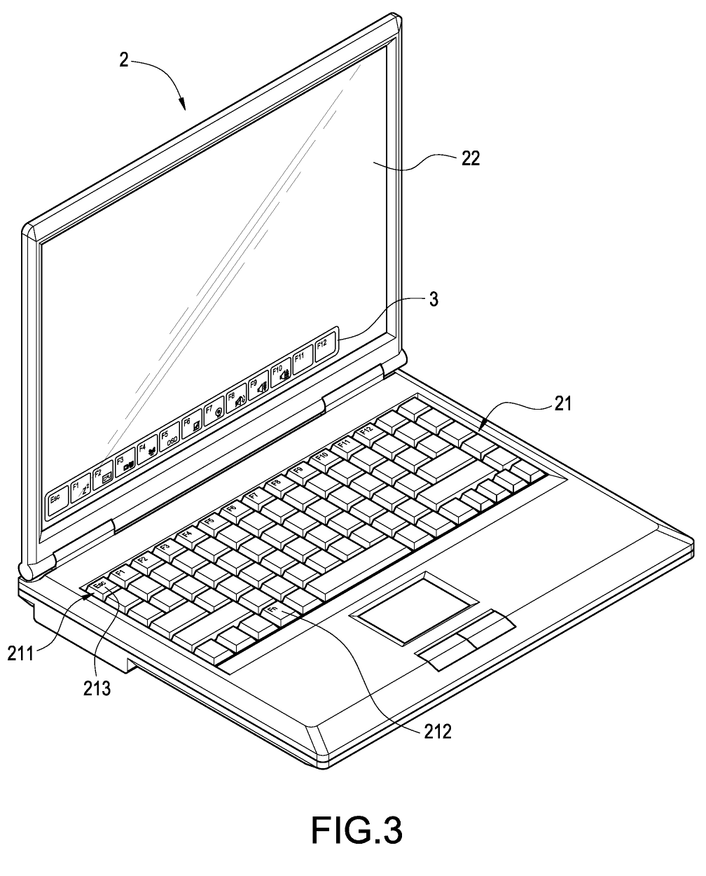

FIG. 3 is a schematic diagram for function display according to a preferred embodiment of the present invention. In FIG. 3, a notebook 2 is used as an example (referred as the computer 2); the computer 2 has a keyboard 21 and a screen 22. Nonetheless, the present invention is applicable to a desktop computer or a barebone and is not limited to the embodiment.

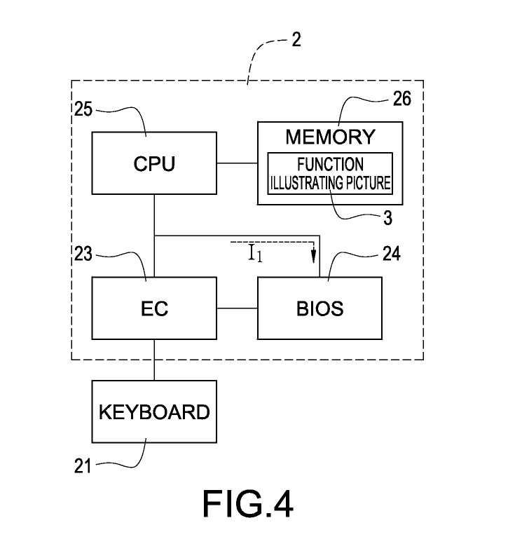

FIG. 4 is a block diagram according to a preferred embodiment of the present invention. In the present invention, an application program is installed in the computer 2. When a user presses a special keys on the keyboard 21, an internal embedded controller (Embedded Controller, EC) 23 in the computer 2 is triggered. Further, the EC 23 generates a trigger message I1 to enable an internal Basic Input Output System (BIOS) 24 in the computer 2 to detect hardware functions setup in the computer 2 and feedback the result to a Central Processing Unit (CPU) 25. The hardware functions respectively correspond to each function key 211 on the keyboard 21. For example, F1 key correspond to entering into hibernation mode function, F5 key correspond to On Screen Display (OSD) function, F8 key correspond to mute function.

The computer 2 displays the function key 211 the screen 22 corresponding function descriptions according to hardware functions detected by the BIOS 24. In details, the computer 2 has a memory 26, wherein a plurality of function illustrating pictures 3 is saved in the memory 26. The computer 2 retrieves the function illustrating pictures 3 matching with hardware function and matching with corresponding relations between the hardware functions and each function key 211 from the memory 26 according to the result detected by the BIOS 24, and display the function illustrating pictures 3 on the screen 22.

The above mentioned special keys are a key combination of a Fn key 212 and one of the function keys 211 on the keyboard 21. In details, the means to trigger executing the method of the present invention can be the user pressing the Fn key 212 and a F5 key simultaneously, but is not limited to the embodiment.

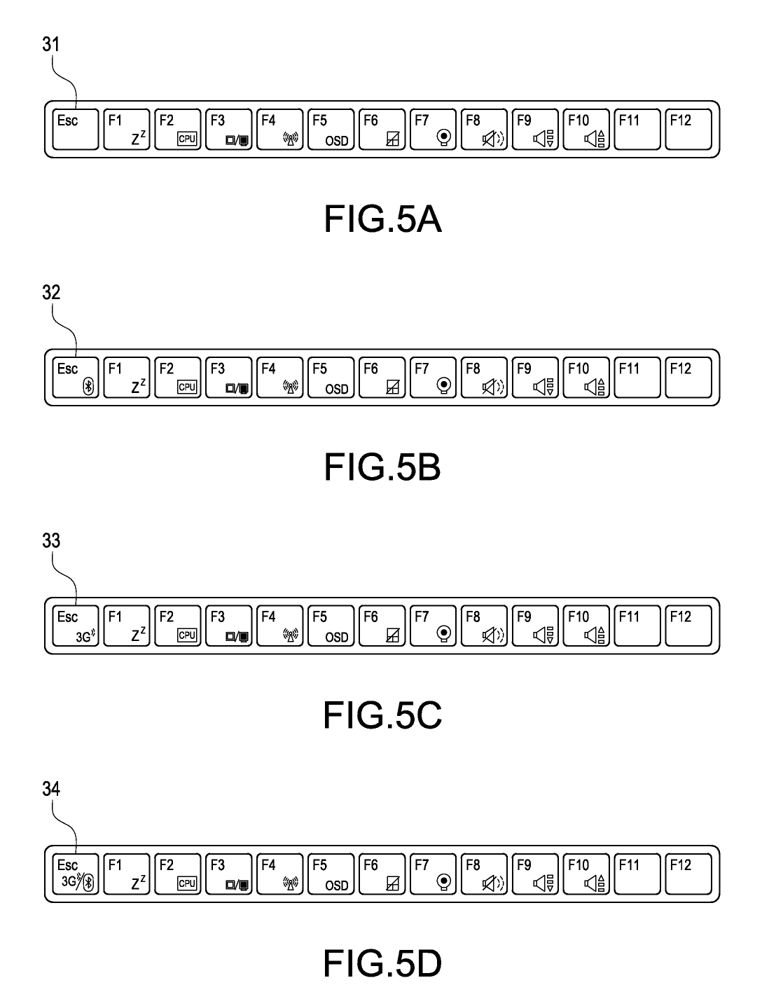

FIG. 5A is a schematic diagram of a function illustrating picture of a preferred embodiment of the present invention. A first function illustrating picture 31 is shown in FIG. 5A. The first function illustrating picture 31 is identical with a function reminding patterns 131 printed on a general keyboard 1 and 1′. If the computer 2 does not have any new added hardware function, and corresponding relations between the hardware functions and each function key 211 do not have any changes, the computer 2 retrieves the first function illustrating picture 31 from the memory 26 and displays the first function illustrating picture 31 on the screen 22 upon the special keys being triggered.

FIG. 5B is a schematic diagram of a function illustrating picture of another preferred embodiment of the present invention. A second function illustrating picture 32 is shown in FIG. 5B. When a hardware function is added to a the computer 2, for example a bluetooth function, the computer 2 retrieves the second function illustrating picture 32 from the memory 26 and displays the second function illustrating picture 32 on the screen 22 upon the special keys being triggered. If bluetooth function corresponds to the Esc key 213 of the function keys 211 (that is, pressing the Fn key 212 and the Esc key 213 simultaneously for launching/terminating the bluetooth function), a bluetooth function reminding pattern (an icon) in the second function illustrating picture 32 is located on the display position of the Esc key 213.

FIG. 5C is a schematic diagram of a function illustrating picture of still another preferred embodiment of the present invention. A third function illustrating picture 33 is shown in FIG. 5C. When another hardware function is added to the computer 2, for example a 3G function, the computer 2 retrieves the third function illustrating picture 33 from the memory 26 and displays the third function illustrating picture 33 on the screen 22 upon the special keys being triggered. If 3G function corresponds to the Esc key 213 (that is, pressing the Fn key 212 and the Esc key 213 simultaneously for launching/terminating the 3G function), a 3G function reminding pattern in the third function illustrating picture 33 is located on the display position of the Esc key 213.

FIG. 5D is a schematic diagram of a function illustrating picture of the other preferred embodiment of the present invention. A fourth function illustrating picture 34 is shown in FIG. 5D. When a plurality of hardware functions are added to the computer 2 simultaneously, for example a bluetooth function and a 3G function are added simultaneously, the computer 2 retrieves the fourth function illustrating picture 34 from the memory 26 and displays the fourth function illustrating picture 34 on the screen 22 upon the special keys being triggered. It should be noted that if the plurality of functions added to the computer 2 are triggered to execute by the same key, for example the Esc key 213 (that is, pressing the Fn key 212 and the Esc key 213 simultaneously for launching/terminating the bluetooth function and the 3G function), the bluetooth function reminding pattern and the 3G function reminding pattern in the fourth function illustrating picture 34 simultaneously are located on the display position of the Esc key 213.

Nonetheless, the above mentioned embodiment is only a preferred embodiment of the present invention; any new hardware function added to the computer 2 is supported by the present invention by adding or modifying the function illustrating picture 3. Further, when the corresponding relations between hardware functions and each function key 211 of the computer 2 are changed, the function illustrating picture 3 is added or modified accordingly, and is not limited to the embodiment.

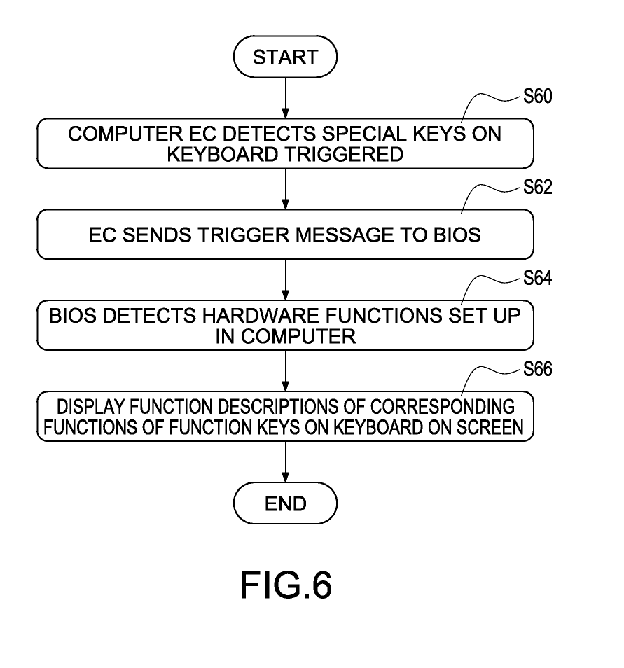

FIG. 6 is a flow chart according to a preferred embodiment of the present invention. In step S60: the EC 23 in the computer 2 detects the special keys being triggered on the keyboard 21. Next in step S62: the EC 23 sends the trigger message I1 to the BIOS 24. Following step S62, the BIOS 24 detects the computer 2 hardware functions setup in the computer 2 in Step S64. Lastly, in step S66: the computer 2 displays function descriptions of corresponding hardware functions of each function key 211 on the keyboard 21 according to hardware function on the screen 22.

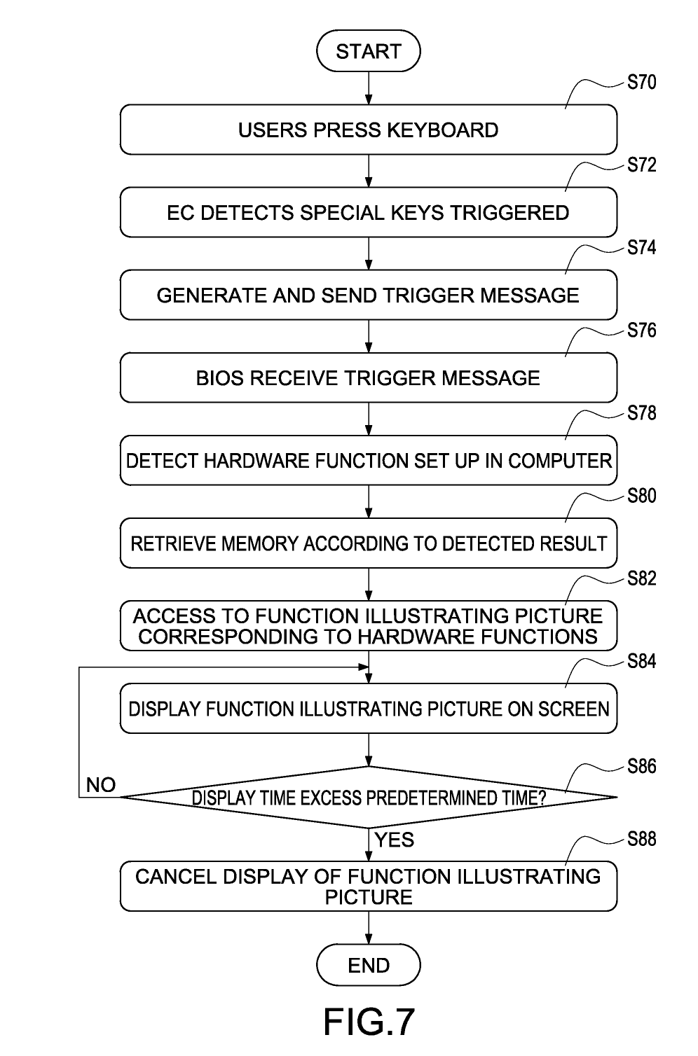

FIG. 7 is a flow chart according to another preferred embodiment of the present invention, which further discloses details of the display method for displaying hardware function according to the present invention. The details are illustrated in the following. First, a user presses a keyboard 21 connecting with the computer 2 (step S70). If the user presses the above mentioned special keys (which are the Fn key 212 and F5 key in the current example), the EC 23 detects that the special keys being triggered (step S72). Next, the EC 23 generates the trigger message I1, and sends the trigger message I1 to the BIOS 24 (step S74).

Following step S74, the BIOS 24 receives the trigger message I1 (step S76), and the BIOS 24 detects hardware functions set up in the computer 2 according to the trigger message I1 (step S78). When the BIOS detects the hardware function set up in the computer 2, the computer 2 retrieves the internal memory 26 according to detect result (step S80) to access to the function illustrating picture 3 corresponding to the hardware functions in the memory 26 (step S82). Lastly, the retrieved function illustrating picture 3 is displayed on the screen 22 (step S84).

For example, if the BIOS detects a 3G function is added to the computer 2, and the 3G function correspond to the Esc key 213 in the function keys 211 in the step S78, the computer 2 retrieves the third function illustrating picture 33 from the memory 26 and displays the third function illustrating picture 33 on the screen 22.

Following step S84, the computer 2 determines if the display time of the function illustrating picture 3 excesses a predetermined time (step S86). If no, the flow returns to step S84, and continues to display the function illustrating picture 3. If the result determined in step S86 is yes, the display of the function illustrating picture 3 is terminated (step S88).

It should be noted that the purpose of the present invention is to remind users corresponding hardware functions of each function key 211. As a result, if users have memorized in mind or written down the corresponding hardware functions of each function key 211. It is not required to execute the display method of the present invention. Users can press a key combination of the Fn key 212 and one of function keys 211 for executing corresponding hardware function.

As the skilled person will appreciate, various changes and modifications can be made to the described embodiments. It is intended to include all such variations, modifications and equivalents which fall within the scope of the invention, as defined in the accompanying claims.

What is claimed is:

1. A display method for displaying computer key function, the computer having a keyboard and a screen, the key function display method comprising:
a) detecting a special keys on the keyboard being triggered via an internal embedded controller (EC) in the computer;
b) sending a trigger message to a Basic Input/Output System (BIOS) at the embedded controller;
c) detecting a hardware function set up in the computer at the basic input output system;
d) displaying function descriptions of corresponding hardware functions of each function key on the keyboard according to the hardware function on the screen.

2. The display method for displaying computer key function of claim 1, wherein the method further comprises a step e: automatically stop displaying the displayed function descriptions on the screen in a predetermined time following step d.

3. The display method for displaying computer key function of claim 1, wherein the method further comprises a step d01 prior to the step d: retrieving a function illustrating picture corresponding to the hardware function from a internal memory at the computer according to detect result following step c;
wherein the function illustrating picture corresponding to each function key on the keyboard is displayed on the screen at the step d.

4. The display method for displaying computer key function of claim 1, wherein the hardware function is bluetooth function.

5. The display method for displaying computer key function of claim 1, wherein the hardware function is 3G function.

6. The display method for displaying computer key function of claim 1, wherein the hardware functions are bluetooth function and 3G function.

7. The display method for displaying computer key function of claim 1, wherein the hardware function corresponds to a Esc key on the keyboard and a function reminding pattern of the hardware function is displayed on the display position of the Esc key in the function illustrating picture.

8. The display method for displaying computer key function of claim 1, wherein the special keys are a key combination including a Fn key and a function key selected from the function keys.

9. The display method for displaying computer key function of claim 8, wherein the key combination include the Fn key and a F5 key.

10. A computer application program installed in a computer, the computer executing a display method for displaying computer key function following the computer loading and executing the application program wherein the computer has a keyboard and a screen, the key function display method comprising:
a) detecting a special keys on the keyboard being triggered via an internal embedded controller (EC) in the computer;
b) sending a trigger message to a Basic Input/Output System (BIOS) at the embedded controller;
c) detecting a hardware function set up in the computer at the basic input output system;
d) displaying function descriptions of corresponding hardware functions of each function key on the keyboard according to the hardware function on the screen.

11. The application program of claim 10, wherein the display method for displaying computer key function further comprises a step d01 prior to the step d: retrieving a function illustrating picture corresponding to the hardware function from a internal memory at the computer according to detect result following step c;
wherein the function illustrating picture corresponding to each function key on the keyboard is displayed on the screen at the step d.

12. A computer readable medium characterized in that the computer readable medium is saved with the application program of claim 10.

13. The computer readable medium of claim 12, wherein the display method for displaying computer key function executed by the application program further comprises a step d01 prior to the step d: retrieving a function illustrating picture corresponding to the hardware function from a internal memory at the computer according to detect result following step c;
wherein the function illustrating picture corresponding to each function key on the keyboard is displayed on the screen at the step d.
